(19) United States
(12) Patent Application Publication
(10) Pub. No.: US 2023/0316708 A1
(43) Pub. Date: Oct. 5, 2023

(54) SIGNAL PROCESSING DEVICE, SIGNAL PROCESSING METHOD, AND PROGRAM

(71) Applicant: SONY GROUP CORPORATION, TOKYO (JP)

(72) Inventors: LEGONG SUN, TOKYO (JP); YUHI KONDO, TOKYO (JP); TAISHI ONO, TOKYO (JP)

(21) Appl. No.: 18/252,401

(22) PCT Filed: Oct. 19, 2021
(86) PCT No.: PCT/JP2021/038544

§ 371 Date: May 10, 2023

(30) Foreign Application Priority Data
Nov. 20, 2020 (JP) 2020-193172

(51) Int. Cl. G06V 10/74; G06V 10/75; G02B 5/30

(52) U.S. Cl. CPC G06V 10/761; G06V 10/751; G02B 5/3083

(57) ABSTRACT

A birefringence imaging unit 20 has a birefringent material and a polarized imaging unit, and the polarized imaging unit generates polarized images based on subject light incident through a birefringent material. The parallax image generator 30 separates images with different polarization angles using the polarized images generated by the polarized imaging unit of the birefringence imaging unit 20, and generates an ordinary ray image and an extraordinary ray image as parallax images. The distance measuring unit 40 calculates a distance to a distance measurement position based on a parallax of the distance measurement position of the subject in the ordinary ray image and the extraordinary ray image generated by the parallax image generator 30. By using polarized images, it is possible to measure distances in portions other than edges, and distance information with high resolution can be obtained more easily than when measuring distances by matching corresponding points in edge images.

### TECHNICAL FIELD

The present technology relates to a signal processing device, a signal processing method, and a program, and enables high-resolution distance information to be obtained easily.

### BACKGROUND ART

Conventionally, various methods have been proposed for non-contact measurement of the distance (hereinafter referred to as “subject distance”) from an imaging device to a subject. For example, an active method that emits infrared rays, ultrasonic waves, lasers, or the like and calculates the subject distance based on the time taken for the reflected wave to return, the angle of the reflected wave, and the like and a passive method that calculates the distance to the subject based on stereo images of the subject without requiring a device for emitting infrared rays and the like.

In the passive method, as illustrated in NPL 1 and NPL 2, edge images are generated using an image based on an ordinary ray and an image based on an extraordinary ray obtained by performing imaging through a birefringent material having a birefringent effect and the subject distance is calculated based on matching results of corresponding points in the edge images.

### CITATION LIST

### Non Patent Literature

### [NPL 1]

Seung-Hwan Baek, et al. (2016) “Birefractive stereo imaging for single-shot depth acquisition”, ACM Trans. Graphics (Proc. SIGGRAPH Asia 2016), vol. 35, no. 6, pp 194, 2016.

### [NPL 2]

Andreas Meuleman, et al. (2020) “Single-shot Monocular RGB-D Imaging using Uneven Double Refraction”, Proceedings of the IEEE/CVF Conference on Computer Vision and Pattern Recognition (CVPR), 2020, pp 2465-2474.

### SUMMARY

### Technical Problem

By the way, when a passive method is used to calculate the distance to the subject without requiring a device for emitting infrared rays or the like, the distance cannot be calculated, for example, since a matching result of corresponding points cannot be obtained for a portion where no edge is detected in the edge images. Therefore, it is difficult to obtain high-resolution distance information.

Therefore, it is an object of the present technology to provide a signal processing device, a signal processing method, and a program that can easily obtain high-resolution distance information.

### Solution to Problem

A first aspect of the present technology provides a signal processing device including:
a polarized imaging unit that generates polarized images based on subject light incident through a birefringent material;
a parallax image generator that separates images with different polarization angles using the polarized images generated by the polarized imaging unit and generates an ordinary ray image and an extraordinary ray image as parallax images; and
a distance measuring unit that calculates a distance to a distance measurement position based on a parallax of the distance position of the subject in the ordinary ray image and the extraordinary ray image generated by the parallax image generator.

In the present technology, the polarized imaging unit generates polarized images based on subject light incident through a birefringent material. The polarized imaging unit has an imaging surface perpendicular to an optical axis of the birefringent material. The polarized imaging unit is configured using polarized pixels whose polarization directions have a phase difference of 90°, and the polarization direction matches the horizontal direction and the vertical direction of the birefringent material. The parallax image generator separates images with different polarization angles using the polarized images generated by the polarized imaging unit and generates an ordinary ray image and an extraordinary ray image as parallax images. For example, the parallax image generator generates the ordinary ray image using a polarized pixel whose polarization direction matches one of the horizontal direction and the vertical direction of the birefringent material, and generates the extraordinary ray image using a polarized pixel whose polarization direction matches the other direction.

The polarized imaging unit is configured using polarized pixels having a predetermined polarization direction and non-polarized pixels that are non-polarized, and the polarization direction matches the horizontal direction or the vertical direction of the birefringent material. The parallax image generator generates one of the ordinary ray image and the extraordinary ray image using the polarized pixels, and generates the other image based on an image generated using the polarized pixels and an image generated using the non-polarized pixels.

The polarized imaging unit is configured using polarized pixels having three or more different polarization directions, and the parallax image generator calculates a polarization model based on pixel values of the polarized pixels having three or more different polarization directions and generates the parallax image based on the calculated polarization model. For example, the parallax image generator searches for a polarization direction in which the other image included in one of the ordinary ray image and the extraordinary ray image is minimized, and generates an image having a phase difference of 90° from the image of the searched polarization direction as the parallax image. The parallax image generator searches for a polarization direction in which an edge component of the polarized image based on the polarization model is minimized. The parallax image generator may search for one polarization direction of two polarized images based on the polarization model, in which a sum of differences for each pixel of the two polarized images whose polarization directions have a phase difference of 90° is maximized. The parallax image generator may search for a polarization direction having a phase difference of 45° from one polarization direction of two polarized images based on the polarization model, in which a sum of differences for each pixel of the two polarized images whose polarization directions have a phase difference of 90° is minimized. The parallax image generator may search for one polarization direction of two polarized images based on the polarization model, in which a sum of differences for each pixel between an added image of two polarized images whose polarization directions have a phase difference of 90° and a polarized image having a phase difference of 45° is minimized.

The parallax image generator generates an ordinary ray image and an extraordinary ray image having a parallax in a horizontal direction as parallax images using a predetermined image parallelization function.

The distance measuring unit calculates a distance to a distance measurement position based on a parallax of the distance measurement position of the subject in the ordinary ray image and the extraordinary ray image generated by the parallax image generator.

A second aspect of the present technology provides a signal processing method including:
allowing a polarized imaging unit to generate polarized images based on subject light incident through a birefringent material;
allowing a parallax image generator to separate images with different polarization angles using the polarized images generated by the polarized imaging unit and generate an ordinary ray image and an extraordinary ray image as parallax images; and
allowing a distance measuring unit to calculate a distance to a distance measurement position based on a parallax of the distance measurement position of the subject in the ordinary ray image and the extraordinary ray image generated by the parallax image generator.

A third aspect of the present technology provides a program for causing a computer to perform distance measurement using polarized images, the computer executing:
separating images with different polarization angles using polarized images based on subject light incident through a birefringent material and generating an ordinary ray image and an extraordinary ray image as parallax images; and
calculating a distance to a distance measurement position based on a parallax of the distance measurement position of the subject in the generated ordinary ray image and extraordinary ray image.

The program of the present technology is a program that can be provided in a general-purpose computer capable of executing various program codes by a storage medium provided in a computer-readable format or a communication medium, for example, a storage medium such as an optical disc, a magnetic disk or a semiconductor memory, or a communication medium such as a network. The provision of such a program in a computer-readable format allows processing according to the program to be realized on the computer.

### BRIEF DESCRIPTION OF DRAWINGS

FIG. 1 is a diagram illustrating the configuration of an embodiment.

FIG. 2 is a diagram illustrating the configuration of a birefringence imaging unit.

FIG. 3 is a diagram illustrating the configuration of a polarized imaging unit.

FIG. 4 is a diagram for explaining the operation of the birefringence imaging unit.

FIG. 5 is a diagram illustrating a configuration of a first embodiment.

FIG. 6 is a diagram illustrating parallax images generated by a parallax image generator.

FIG. 7 is a flowchart illustrating a calibration operation.

FIG. 8 is a diagram for explaining calibration in which the z-axis of a birefringent material is perpendicular to the image sensor.

FIG. 9 is a diagram for explaining calibration with the y-axis of a birefringent material as a predetermined polarization direction of a polarizing filter.

FIG. 10 is a diagram illustrating a case in which pixel position conversion processing is performed using an image parallelization function.

FIG. 11 is a flowchart illustrating an operation of the first embodiment.

FIG. 12 is a diagram for explaining corresponding point matching.

FIG. 13 is a diagram illustrating a configuration of a second embodiment.

FIG. 14 is a diagram illustrating an image generated by a parallax image generator.

FIG. 15 is a flowchart illustrating an operation of the second embodiment.

FIG. 16 is a diagram illustrating the relationship between the polarization direction and the pixel value of the polarized pixel.

FIG. 17 is a diagram illustrating a configuration of a third embodiment.

FIG. 18 is a diagram illustrating an image generated by a parallax image generator.

FIG. 19 is a flowchart illustrating the calibration operation in the third embodiment.

FIG. 20 is a flowchart illustrating an operation of the third embodiment.

FIG. 21 is a diagram illustrating a first search method.

FIG. 22 is a diagram illustrating a second search method.

FIG. 23 is a diagram illustrating a third search method.

FIG. 24 is a diagram illustrating a fourth search method.

FIG. 25 is a diagram illustrating another pixel configuration (part 1) of the polarized imaging unit.

FIG. 26 is a diagram illustrating another pixel configuration (part 2) of the polarized imaging unit.

FIG. 27 is a diagram illustrating another pixel configuration (part 3) of the polarized imaging unit.

### DESCRIPTION OF EMBODIMENTS

An embodiment for implementing the present technique will be described below. Here, description will proceed in the following order.
1. Configuration and operation of embodiment
2. Configuration and operation of first embodiment
3. Configuration and operation of second embodiment
4. Configuration and operation of third embodiment
5. Modification examples
6. Application examples

### 1. CONFIGURATION AND OPERATION OF EMBODIMENT

The present technology performs imaging of a distance measurement target through a birefringent material to generate polarized images. The present technology separates images with different polarization angles using the generated polarized images, generates an ordinary ray image and an extraordinary ray image as parallax images, and calculates a distance to a distance measurement position based on a parallax of a distance measurement position in the ordinary ray image and the extraordinary ray image.

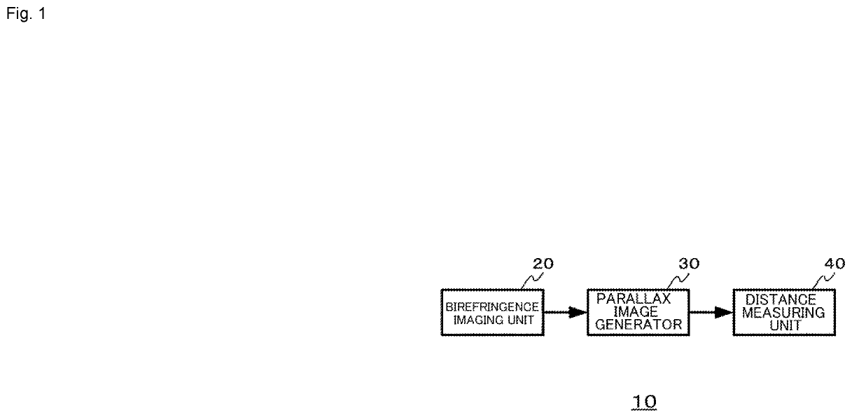

FIG. 1 illustrates the configuration of the embodiment. A measurement system 10 has a birefringence imaging unit 20, a parallax image generator 30 and a distance measuring unit 40.

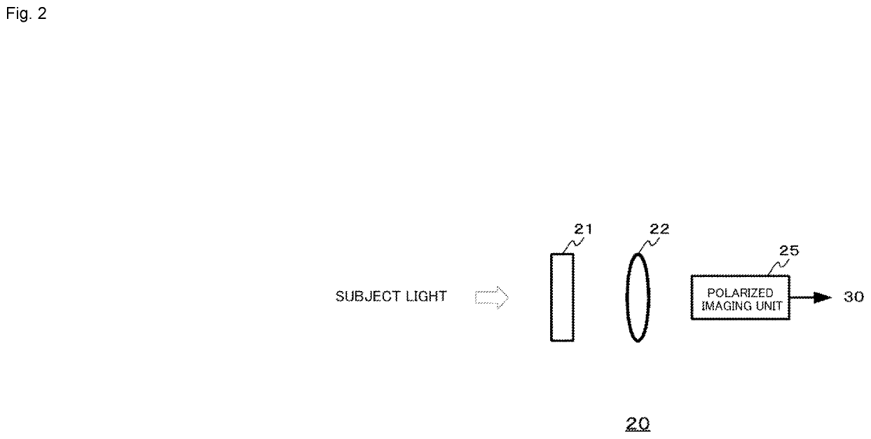

FIG. 2 illustrates the configuration of the birefringence imaging unit. The birefringence imaging unit 20 has a birefringent material 21, an imaging optical system 22 and a polarized imaging unit 25.

The birefringent material 21 is a material having a birefringent effect, and the incident light having passed through the birefringent material is divided into ordinary and extraordinary rays by the birefringent material 21. The birefringent material 21 is, for example, α-BBO crystal, yttrium-vanadate crystal, calcite, quartz, or the like.

The imaging optical system 22 is configured using a focus lens, a zoom lens, and the like. The imaging optical system 22 drives a focus lens, a zoom lens, and the like to form an optical image of a measurement target subject on the imaging surface of the birefringence imaging unit 20. The imaging optical system 22 may be provided with an iris (aperture) mechanism, a shutter mechanism, or the like.

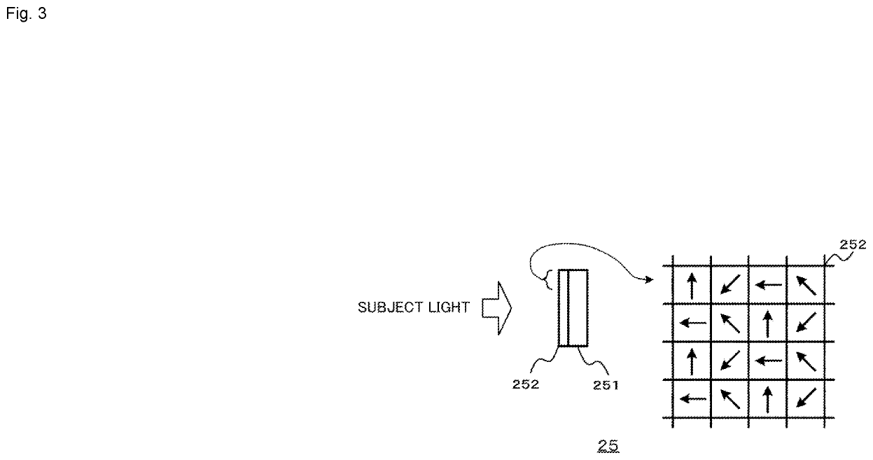

The polarized imaging unit 25 is configured using a polarization element and an image sensor, and generates a polarized image. FIG. 3 illustrates the configuration of the polarized imaging unit. The polarized imaging unit 25 acquires polarized images by arranging a polarizing filter 252 composed of polarized pixels having one or more polarization directions or polarized pixels and non-polarized pixels in an image sensor 251 such as a CMOS (Complementary Metal Oxide Semiconductor) or a CCD (Charge Coupled Device). The polarizing filter 252 can extract linearly polarized light from subject light, and uses a wire grid, photonic liquid crystal, or the like, for example. Note that the arrows in the polarizing filter 252 indicate, for example, the polarization directions for each pixel or for each of a plurality of pixels, and FIG. 3 illustrates a case in which there are four polarization directions.

The birefringence imaging unit 20 configured in this way generates, as parallax images, a first polarized image based on ordinary rays and a second polarized image based on extraordinary rays.

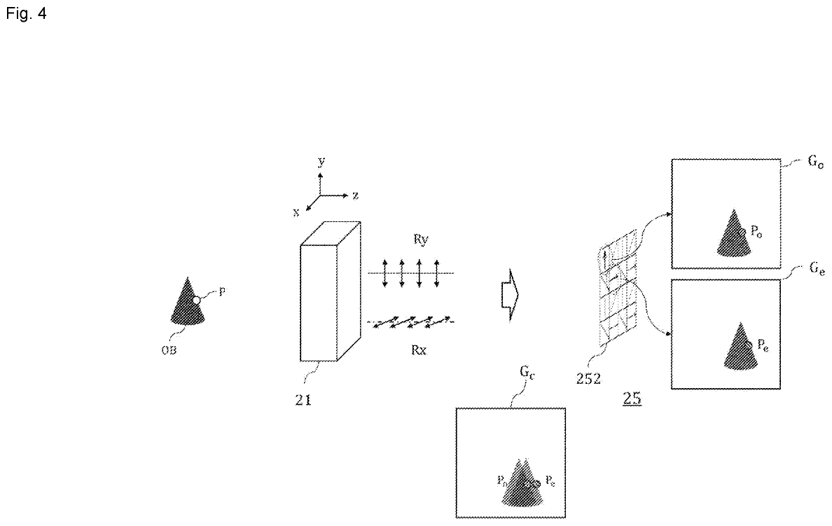

FIG. 4 is a diagram for explaining the operation of the birefringence imaging unit. Note that FIG. 4 illustrates the case of measuring the distance to a distance measurement position P on the subject OB.

When the subject light representing the subject OB is incident on the birefringent material 21, the subject light is divided into an ordinary ray Rx and an extraordinary ray Ry and emitted to the polarized imaging unit 25. That is, the polarized imaging unit 25 receives a ray representing an image Gc obtained by mixing an image based on the ordinary ray Rx and an image based on the extraordinary ray Ry.

The image sensor of the polarized imaging unit 25 photoelectrically converts the light incident through the polarizing filter 252 to generate a polarized image. For example, in the case of FIG. 4, the polarized images include an ordinary ray image Go generated using polarized pixels through which the ordinary ray Rx is transmitted through the polarizing filter 252, and an extraordinary ray image Ge generated using polarized pixels through which the extraordinary ray Ry is transmitted through the polarizing filter 252. Note that the distance measurement position in the ordinary ray image Go is the distance measurement position Po, and the distance measurement position in the extraordinary ray image Ge is the distance measurement position Pe.

The parallax image generator 30 separates the ordinary ray image Go and the extraordinary ray image Ge based on a mixed image generated by the birefringence imaging unit 20 to generate a parallax image. The parallax image generator 30 may generate an average image by performing gain adjustment corresponding to a polarizing filter with respect to a polarized image for each polarization direction and a non-polarized image generated using non-polarized pixels (not illustrated) having no polarizing filter and generate a parallax image based on the polarized images for each polarization direction or the polarized images and the average image. Note that the average image is an image representing an average change in luminance when the polarization direction is changed. When the image sizes of the polarized images or the average images for each polarization direction are different, the parallax image generator 30 performs interpolation processing or the like so that the image sizes (the numbers of pixels in the horizontal and vertical directions) of the polarized images and the average images for each polarization direction are equal.

The distance measuring unit 40 performs corresponding point matching processing using the parallax images generated by the parallax image generator 30, and calculates the parallax of the distance measurement position P. The distance measuring unit 40 calculates the distance to the distance measurement position P on the subject OB based on the calculated parallax.

### 2. CONFIGURATION AND OPERATION OF FIRST EMBODIMENT

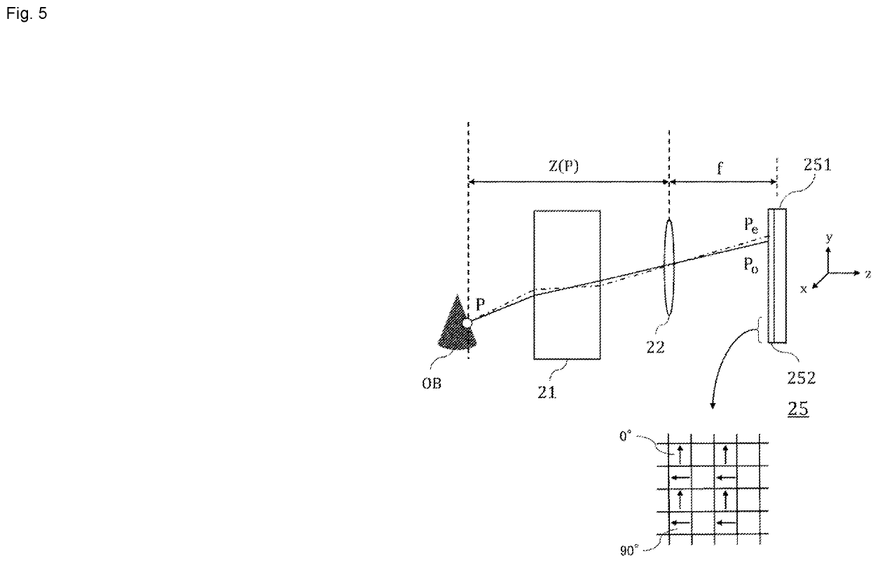

Next, the configuration and operation of the first embodiment will be described. In the first embodiment, the polarized imaging unit 25 has polarized pixels having at least two orthogonal polarization directions. FIG. 5 illustrates the configuration of the first embodiment, and the polarized imaging unit 25 has a polarized pixel with a polarization direction of 0° and a polarized pixel with a polarization direction of 90°. Note that the pixels other than the polarized pixel with the polarization direction of 0° and the polarized pixel with the polarization direction of 90° may be polarized pixels with different polarization directions or may be non-polarized pixels.

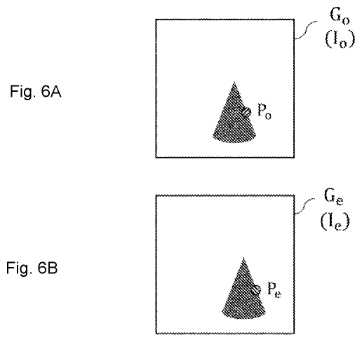

The parallax image generator 30 generates, as parallax images, an ordinary ray image based on ordinary rays and an extraordinary ray image based on extraordinary rays from the polarized images acquired by the birefringence imaging unit 20. FIG. 6 illustrates parallax images generated by the parallax image generator. FIG. 6(a) illustrates an ordinary ray image Go representing an optical image of ordinary rays, and FIG. 6(b) illustrates an extraordinary ray image Ge representing an optical image of extraordinary rays. Note that the distance measurement position in the ordinary ray image Go is the distance measurement position Po, and the distance measurement position in the extraordinary ray image Ge is the distance measurement position Pe. The pixel value of the ordinary ray image Go is assumed to be “I₀”, and the pixel value of the extraordinary ray image Ge is assumed to be “Iₑ”.

The distance measuring unit 40 performs corresponding point matching processing using the ordinary ray image Go and the extraordinary ray image Ge generated by the parallax image generator 30, and calculates the parallax of the distance measurement position P. The distance measuring unit 40 calculates the distance Z(P) to the distance measurement position P on the subject OB based on the calculated parallax.

Next, the operation of the first embodiment will be described. A baseline length B, which is the interval between the acquisition position of the ordinary ray image Go and the acquisition position of the extraordinary ray image Ge, which cause a parallax between the distance measurement positions Po and Pe, is measured in advance. In the birefringence imaging unit 20, the focal length f is when the distance measurement position P of the subject OB is in focus.

Here, calibration is performed such that the pixel value based on the ordinary ray that has passed through the birefringent material from the distance measurement position P on the subject OB is obtained in the polarized pixel with the polarization direction of 0°, and the pixel value based on the extraordinary ray that has passed through the birefringent material from the distance measurement position P on the subject OB is obtained in the polarized pixel with the polarization direction of 90°.

The parallax image generator 30 generates an ordinary ray image Go representing an optical image of ordinary rays using polarized pixels with the polarization direction of 0°, and an extraordinary ray image Ge representing an optical image of extraordinary rays using polarized pixels with the polarization direction of 90°.

The distance measuring unit 40 performs matching processing of the distance measurement position P using the ordinary ray image Go and the extraordinary ray image Ge generated by the parallax image generator 30, and calculates a parallax ∥PoPe∥, which is the difference between the distance measurement position Po in the ordinary ray image Go and the distance measurement position Pe in the extraordinary ray image Ge. The distance measuring unit 40 calculates, based on Equation (1), the distance Z(P) to the distance measurement position P in the subject OB based on the calculated parallax ∥PoPe∥, the baseline length B, and the focal length f.

$$[ Math . 1 ]$$

$$Z ( P ) = \frac{f}{‖ {P}_{o} {P}_{e} ‖} B \qquad ( 1 )$$

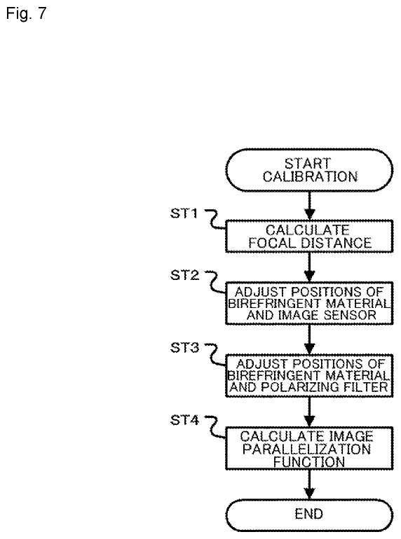

The measurement system 10 performs calibration so that an ordinary ray image based on ordinary rays and an extraordinary ray image based on extraordinary rays can be separated from the mixed image generated by the birefringence imaging unit 20. FIG. 7 is a flowchart illustrating the calibration operation.

In step ST1, the measurement system calculates the focal length. As in the conventional calibration method, the measurement system 10 performs calibration using internal parameters, calculates the focal length f, and then the process proceeds to step ST2.

In step ST2, the measurement system adjusts the positions of the birefringent material and the image sensor. The measurement system 10 adjusts the positions of the birefringent material and the image sensor so that the z-axis (optical axis) of the birefringent material is perpendicular to the imaging surface of the image sensor of the polarized imaging unit.

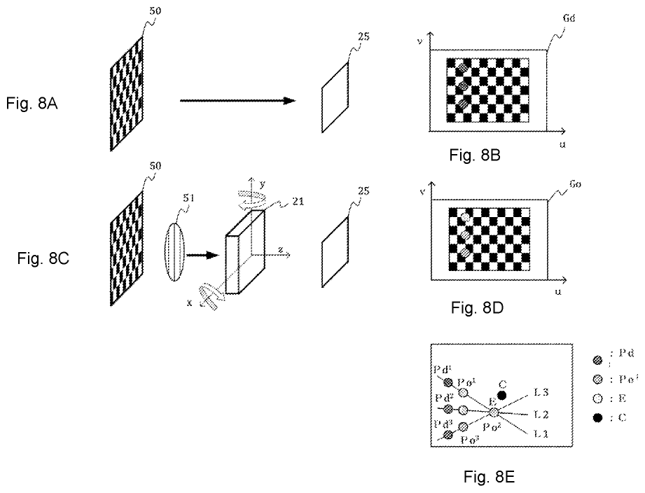

FIG. 8 is a diagram for explaining calibration in which the z-axis of the birefringent material is made perpendicular to the imaging surface of the image sensor. For the calibration in which the z-axis of the birefringent material is made perpendicular to the image sensor, the calibration method described in NPL 1, for example, is used. Note that the imaging optical system 22 is omitted in FIG. 8.

In this calibration method, as illustrated in FIG. 8(a), a checkerboard 50 is imaged by the polarized imaging unit 25 without passing through the birefringent material 21, and a reference image Gd illustrated in FIG. 8(b) is obtained. As illustrated in FIG. 8(c), the checkerboard 50 is imaged by the polarized imaging unit 25 via the polarizing plate 51 and the birefringent material 21. Here, the polarizing plate 51 causes a linearly polarized ray having the same polarization direction as the y-axis of the birefringent material 21 to be incident on the birefringent material 21, and causes the polarized imaging unit 25 to observe only the ordinary ray, thereby obtaining the ordinary ray image Go illustrated in FIG. 8(d). The circle marks illustrated in FIGS. 8(b) and 8(d) indicate keypoints on the checkerboard 50.

FIG. 8(e) illustrates the keypoint group Pdⁱ(i=1, 2, 3, . . . L, L=3 in FIG. 8) in the reference image Gd, and the keypoint group Poⁱ(i=1, 2, 3, . . . L, and L=3 in FIG. 8) in the ordinary ray image Go.

In the calibration method described above, a straight line Li connecting the keypoint pairs at equal positions on the checkerboard is calculated for each keypoint pair. For example, a straight line L1 connecting the keypoints Pd¹ and Po¹, a straight line L2 connecting the keypoints Pd² and Po², and a straight line L3 connecting the keypoints Pd³ and Po³ are calculated. An intersection point E of a plurality of straight lines Li (i=1, 2, 3, . . . L, L=3 in FIG. 8) is calculated. Equation (2) is an equation representing a straight line Li connecting the corresponding keypoints in the keypoint group Pdⁱ and the keypoint group Poⁱ.

[Math. 2]

Lᵢ={(u,v)|aᵢu+bᵢv+cᵢ=0} (2)

In this calibration method, the birefringent material 21 is rotated around the y-axis and the x-axis to adjust the position of the intersection point E, and the intersection point E is set to the position of the image center C.

The measurement system adjusts the birefringent material 21 so that the intersection point E is positioned at the image center C, thereby making the z-axis of the birefringent material perpendicular to the imaging surface of the image sensor, and then, the process proceeds to step ST3.

In step ST3, the measurement system adjusts the positions of the birefringent material and the polarizing filter. In the measurement system 10, the y-axis of the birefringent material matches the 0-degree direction of the polarizing filter in the polarized imaging unit so that a polarized image generated using polarized pixels with the polarization direction of 0° is an ordinary ray image, and a polarized image generated using polarized pixels with the polarization direction of 90° is an extraordinary ray image. In step ST3, the y-axis of the birefringent material and the 90-degree direction of the polarizing filter may be matched so that the 90-degree polarized image represents the ordinary ray image and the 0-degree polarized image represents the extraordinary ray image.

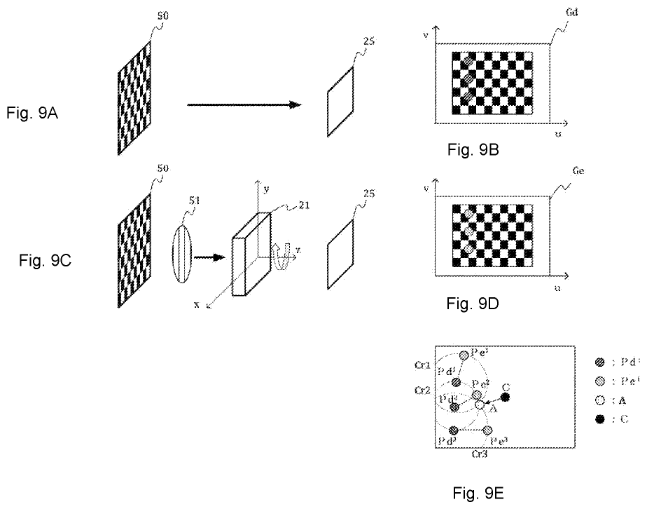

FIG. 9 is a diagram for explaining calibration in which the y-axis of the birefringent material corresponds to a predetermined polarization direction (for example, 0° or 90°) of the polarizing filter. For the calibration in which the y-axis of the birefringent material corresponds to the predetermined polarization direction of the polarizing filter, the calibration method described in NPL 1, for example, is used. Note that the imaging optical system 22 is omitted in FIG. 9.

In this calibration method, as illustrated in FIG. 9(a), the checkerboard 50 is imaged by the polarized imaging unit 25 without passing through the birefringent material 21, and the reference image Gd illustrated in FIG. 9(b) is acquired. As illustrated in FIG. 9(c), the checkerboard 50 is imaged by the polarized imaging unit 25 via the polarizing plate 51 and the birefringent material 21. Here, the polarizing plate 51 causes a linearly polarized ray having a polarization direction orthogonal to the y-axis of the birefringent material 21 to be incident on the birefringent material 21 and causes the polarized imaging unit 25 to observe only the extraordinary ray, thereby acquiring an extraordinary ray image Ge illustrated in FIG. 9(d). The circle marks illustrated in FIGS. 9(b) and 9(d) indicate the positions of keypoints on the checkerboard 50.

FIG. 9(e) illustrates the keypoint group Pdⁱ(i=1, 2, 3, . . . L, L=3 in FIG. 9) in the reference image Gd, and the keypoint group Peⁱ(i=1, 2, 3, . . . L, and L=3 in FIG. 9) in the extraordinary ray image Ge.

In the above-described calibration method, using keypoint pairs at equal positions on the checkerboard, a circle Cri centered on the keypoint of the keypoint group Pdⁱ and passing through the corresponding keypoint of the keypoint group Peⁱ is calculated for each keypoint pair. For example, a circle Cr1 centered on the keypoint Pd¹ and passing through the keypoint Pe¹, a circle Cr2 centered on the keypoint Pd² and passing through the keypoint Po², and a circle Cr centered on the keypoint Pd³ and passing through the keypoint Po³ are calculated. An intersection point A of a plurality of circles Cri (i=1, 2, 3, . . . L, L=3 in FIG. 9) is calculated.

In this calibration method, the position of the intersection point A is adjusted by rotating the birefringent material 21 about the z-axis so that a vector connecting the intersection point A and the image center C is aligned in the vertical direction of the image (for example, the upward vertical direction). In this calibration method, the birefringent material 21 is adjusted so that the vector connecting the intersection point A and the image center C is in the vertical direction of the image, whereby the y-axis of the birefringent material corresponds to the 0-degree polarization direction of the polarizing filter.

The measurement system performs calibration in which the y-axis of the birefringent material corresponds to a predetermined polarization direction of the polarizing filter, and then, the process proceeds to step ST4.

In step ST4, the measurement system calculates an image parallelization function. The measurement system 10 calculates an image parallelization function T that converts the polarized image generated by the birefringence imaging unit 20 into a stereo mixed image obtained by mixing right-viewpoint images and left-viewpoint images. The image parallelization function T is calculated using the method described in NPL 2, for example.

In this method, the image parallelization function T is calculated using a baseline length B set in advance. As illustrated in Equation (3), the image parallelization function T is a function that converts the coordinates t(u,v) of the image I before parallelization to the coordinates (u,v) of the image Ir obtained by mixing right-viewpoint images and left-viewpoint images.

[Math. 3]

Iᵣ=T(I)={Iᵣ(u,v)←I[t(u,v)]} (3)

The image parallelization function T can be calculated using, for example, a recursive method. Specifically, as illustrated in Equation (4), coordinates t(u,v) are calculated from coordinates (0,v) at the left end to (u,v) at the right end. Here, the baseline b(u,v) of the pixel (u,v) is calculated based on Equation (5). Note that in Equation (5), the focal length f and the distance Zcb to the checkerboard are set in advance before calculating the image parallelization function. ∥PoPe∥ is defined by keypoints on a checkerboard, and pixels that are not keypoints are calculated by interpolation using values of neighboring keypoints.

$$[ Math . 4 ]$$

$$\begin{matrix}t ( 0 , v ) = ( 0 , v ) \\ \begin{matrix}t ( 1 , v ) = t ( 1 - 1 , v ) + b [ t ( 1 - 1 , v ) ] / \\ B = t ( 0 , v ) + b [ t ( 0 , v ) ] / \\ B = ( 0 , v ) + b [ ( 0 , v ) ] / B\end{matrix} \\ t ( 2 , v ) = t ( 1 , v ) + b [ t ( 1 , v ) ] / B \\ … \\ t ( u , v ) = t ( u - 1 , v ) + b [ t ( u - 1 , v ) ] / B\end{matrix} \} \qquad ( 4 )$$

$$b ( u , v ) = Z \times ‖ {P}_{o} {P}_{e} ‖ / f \qquad ( 5 )$$

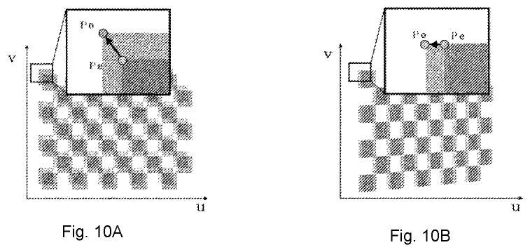

FIG. 10 illustrates a case in which pixel position conversion processing is performed using an image parallelization function. FIG. 10(a) illustrates the image before conversion, and the keypoint Po in the ordinary ray image and the corresponding keypoint Pe in the extraordinary ray image are not parallel. FIG. 10(b) illustrates the image after conversion, and by performing pixel position conversion processing using the image parallelization function T, the keypoint Po of the ordinary ray image and the corresponding keypoint Pe in the extraordinary ray image become parallel. That is, the image after conversion is a stereo mixed image in which the ordinary ray image and the extraordinary ray image are images from the right viewpoint and the left viewpoint, and the keypoint has a parallax according to the distance.

After performing the calibration of FIG. 7, the measurement system 10 performs the distance measurement operation of the distance measurement position.

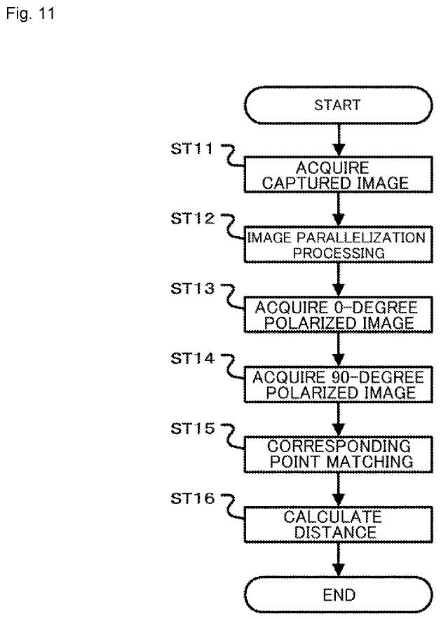

FIG. 11 is a flowchart illustrating the operation of the first embodiment. In step ST11, the measurement system acquires a captured image. The birefringence imaging unit 20 of the measurement system 10 performs imaging so that the distance measurement position P of the measurement target subject OB is included in the angle of view and acquires a polarized image, and then, the process proceeds to step ST12.

In step ST12, the measurement system performs image parallelization processing. The parallax image generator 30 of the measurement system 10 performs image parallelization processing on the polarized image acquired by the birefringence imaging unit 20 using the image parallelization function T calculated by calibration. The parallax image generator 30 performs image parallelization processing to convert the polarized image into a stereo image in which the ordinary ray image and the extraordinary ray image are images from the right viewpoint and the left viewpoint, and the distance measurement position has a parallax according to the distance, and then, the process proceeds to step ST13.

In step ST13, the measurement system acquires a 0-degree polarized image. The parallax image generator 30 of the measurement system 10 acquires a 0-degree polarized image (ordinary ray image) generated using the polarized pixel with the polarization direction of 0° as the image from one viewpoint from the stereo mixed image generated in step ST12, and then, the process proceeds to step ST14.

In step ST14, the measurement system acquires a 90-degree polarized image. The parallax image generator 30 of the measurement system 10 acquires a 90-degree polarized image (extraordinary ray image) generated using the polarized pixel with the polarization direction of 90° as the image from the other viewpoint from the stereo mixed image generated in step ST12, and then, the process proceeds to step ST15.

In step ST15, the measurement system performs corresponding point matching. The distance measuring unit 40 of the measurement system 10 performs corresponding point matching using the 0-degree polarized image (ordinary ray image) that is an image from one viewpoint acquired in step ST13, and the 90-degree polarized image (extraordinary ray image) that is an image from the other viewpoint acquired in step ST14 and calculates the positional difference ∥PoPe∥ between the distance measurement position Po in the ordinary ray image and the distance measurement position Pe in the extraordinary ray image, and then, the process proceeds to step ST16.

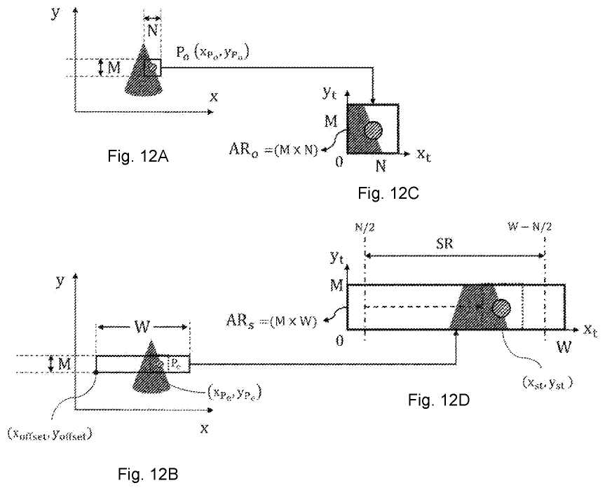

FIG. 12 is a diagram for explaining corresponding point matching. FIG. 12(a) illustrates the first image used for corresponding point matching, and FIG. 12(b) illustrates the second image used for corresponding point matching. In the following description, the first image is the ordinary ray image and the second image is the extraordinary ray image, but the first image may be the extraordinary ray image and the second image may be the ordinary ray image.

FIG. 12(c) illustrates a template image. The template image is an image of, for example, a region ARo having a size of M×N pixels and centered at the distance measurement position Po in the first image (ordinary ray image Go). When conversion processing is performed using the image parallelization function T, the keypoint Po in the ordinary ray image and the corresponding keypoint Pe in the extraordinary ray image are located at positions separated in the horizontal direction according to the distance to the distance measurement position. Therefore, a search range ARs has a size of W×M pixels, and is positioned at the same position in the vertical direction as the template image in the second image (extraordinary ray image Ge). That is, when the distance measurement position Po has coordinates (x_{Po}, y_{Po}), the coordinates (x_{offset}, y_{offset}) of the reference position of the search range ARs illustrated in FIG. 12(d) are the positions illustrated in Equation (6).

$$[ Math . 5 ]$$

$$( {x}_{offset} , {y}_{offset} ) = ( {x}_{Po} - \frac{W}{2} , {y}_{Po} - \frac{M}{2} ) \qquad ( 6 )$$

The distance measuring unit 40 moves the center position (xₛ, yₛ) of the reference image, which has a region size equal to that of the template image, within the range illustrated by Equations (7) and (8), and calculates the center position (xₛₜ, yₛₜ) that minimizes the error between the template image and the reference image of the search range ARs. The distance measuring unit 40 sets the distance measurement position Pe as the position corresponding to the distance measurement position Po where the error is minimized. In this case, the coordinates (x_{Pe}, y_{Pe}) of the distance measurement position Pe are the coordinates illustrated in Equation (9).

$$[ Math . 6 ]$$

$${x}_{sc} ∈ ( \frac{N}{2} , W - \frac{N}{2} ) \qquad ( 7 )$$

$${y}_{sc} = \frac{M}{2} \qquad ( 8 )$$

$$( {x}_{{P}_{e}} , {y}_{{P}_{e}} ) = ( {x}_{st} + {x}_{offset} , {y}_{s t} + {y}_{offset} ) = ( {x}_{st} + {x}_{{P}_{o}} - \frac{w}{2} , {y}_{{P}_{o}} ) \qquad ( 9 )$$

When the distance measuring unit 40 uses, for example, SAD as the error between the template image and the search image, the coordinates (xₛₜ, yₛₜ) at which the error is minimized are the coordinates (xₛ, yₛ) when the evaluation value H illustrated in Equation (10) is obtained. Note that SAD is defined as illustrated in Equation (11).

$$[ Math . 7 ]$$

$$H = {min}_{( {x}_{s} , {y}_{s} )} SAD ( {x}_{s} , {y}_{s} ) = min SAD ( {x}_{s} , \frac{M}{2} ) \qquad ( 10 )$$

$$\begin{matrix}SAD ( x , y ) = {\sum }_{i = 0}^{N} {\sum }_{j = 0}^{M} Diff ( x + i - \frac{N}{2} , y + j - \frac{M}{2} , i , j ) \\ = {\sum }_{i = 0}^{N} {\sum }_{j = 0}^{M} \vert {I}_{s} ( x + i - \frac{N}{2} , y + j - \frac{M}{2} ) - {I}_{t} ( i , j ) \vert\end{matrix} \qquad ( 11 )$$

The distance measuring unit 40 performs such corresponding point matching, and calculates the parallax ∥PoPe∥ based on Equation (12).

[Math. 8]

∥PₒPₑ∥=\sqrt{(Po^{x}−Pe^{x})+(Po^{y}−Pe^{y})} (12)

The measurement system calculates the distance in step ST16. The distance measuring unit 40 of the measurement system performs calculation of Equation (1) using the focal distance f and the baseline length B set in advance and the parallax ∥PoPe∥ calculated in step ST15 and calculates the distance Z(P) to the distance measurement position P.

As described above, according to the first embodiment, it is possible to generate a polarized image representing an optical image based on ordinary rays and a polarized image representing an optical image based on extraordinary rays and measure the distance to a distance measurement position based on the parallax between the distance measurement positions in the two polarized images. Therefore, corresponding point matching can be performed even in a portion where no edge is detected, and distance information with higher resolution than when edge images are used can be obtained.

### 3. CONFIGURATION AND OPERATION OF SECOND EMBODIMENT

Next, a second embodiment will be described. In the first embodiment described above, the case in which the polarized imaging unit 25 is configured using polarized pixels whose polarization directions are orthogonal to each other has been described. In the second embodiment, a case in which the polarized imaging unit 25 is configured using polarized pixels having one polarization direction and non-polarized pixels will be described.

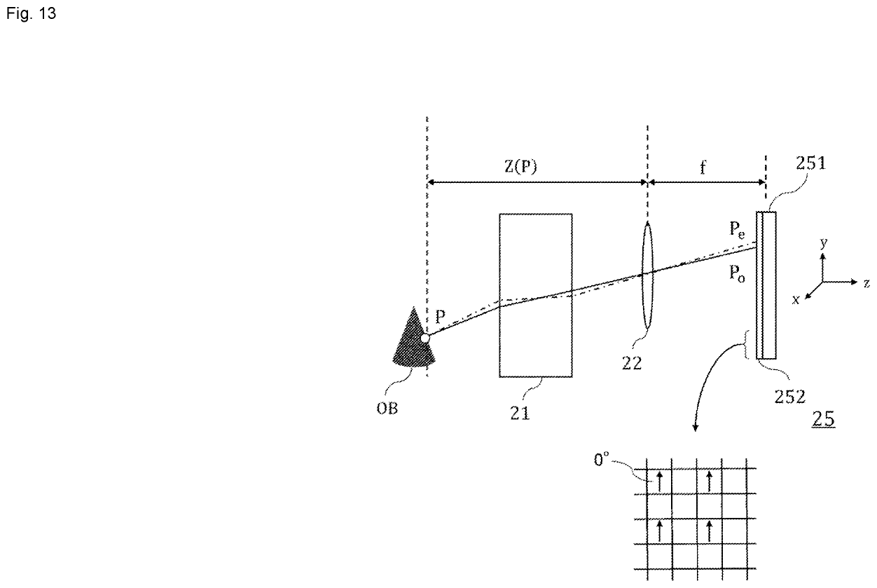

FIG. 13 illustrates the configuration of the second embodiment, and the polarized imaging unit 25 has polarized pixels with a polarization direction of 0° and non-polarized pixels. In the second embodiment, similarly to the first embodiment, the baseline length B and the focal length f are measured in advance. When the polarization direction is 0° , the calibration is performed so that the pixel value based on the ordinary ray having passed through the birefringent material from the distance measurement position P on the subject OB, for example, can be obtained.

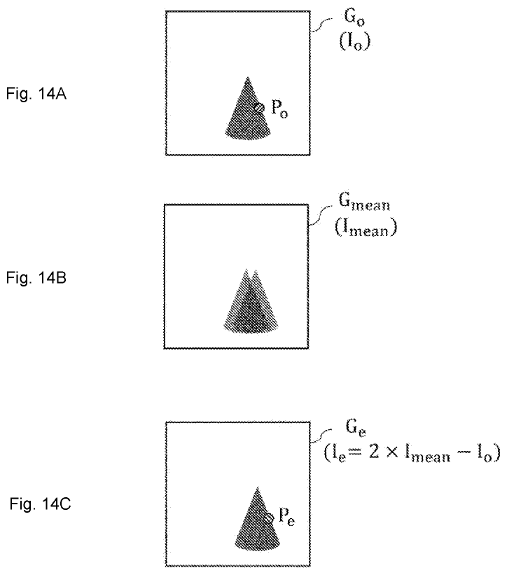

The parallax image generator 30 generates an average image from the polarized image acquired by the birefringence imaging unit 20 using the polarized image based on the ordinary ray and non-polarized pixels. FIG. 14 illustrates images generated by the parallax image generator, and FIG. 14(a) illustrates an ordinary ray image Go representing an optical image of ordinary rays. FIG. 14(b) illustrates an average image Gmean generated using non-polarized pixels, and the pixel value of the average image indicates the average pixel value of the ordinary ray image and the extraordinary ray image. The parallax image generator 30 generates an extraordinary ray image Ge illustrated in FIG. 14(c) from the ordinary ray image Go and the average image Gmean, as will be described later. Note that the distance measurement position in the ordinary ray image Go is the distance measurement position Po, and the distance measurement position in the extraordinary ray image Ge is the distance measurement position Pe.

The distance measuring unit 40 performs corresponding point matching processing using the ordinary ray image Go and the extraordinary ray image Ge generated by the parallax image generator 30, and calculates the parallax of the distance measurement position P. The distance measuring unit 40 calculates the distance Z(P) to the distance measurement position P on the subject OB based on the calculated parallax.

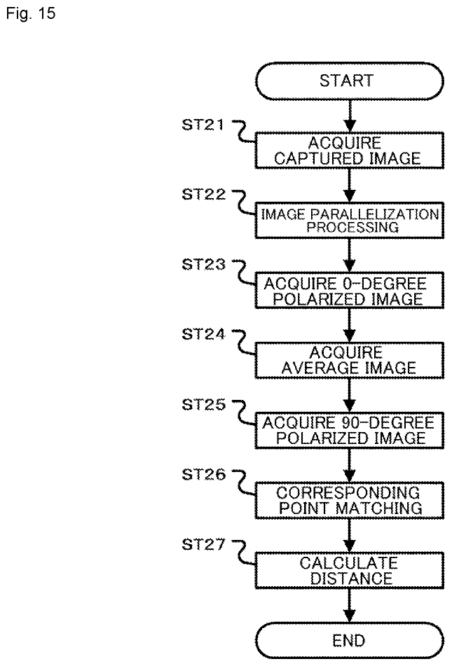

FIG. 15 is a flowchart illustrating the operation of the second embodiment. In step ST21, the measurement system acquires a captured image. The birefringence imaging unit 20 of the measurement system 10 performs imaging so that the distance measurement position P of the measurement target subject OB is included in the angle of view and acquires a polarized image, and then, the process proceeds to step ST22.

In step ST22, the measurement system performs image parallelization processing. The parallax image generator 30 of the measurement system 10 performs image parallelization processing on the polarized image acquired by the birefringence imaging unit 20 using the image parallelization function T calculated by calibration, and ordinary ray image and extraordinary ray image to convert the polarized image into a stereo mixed image in which the ordinary ray image and the extraordinary ray image are images from the right viewpoint and the left viewpoint, and the distance measurement position has a parallax according to the distance, and then, the process proceeds to step ST23.

In step ST23, the measurement system acquires a 0-degree polarized image. The parallax image generator 30 of the measurement system 10 acquires a 0-degree polarized image (ordinary ray image Go) generated using the polarized pixel with the polarization direction of 0° as the image from one viewpoint from the stereo mixed image generated in step ST22, and then, the process proceeds to step ST24.

In step ST24, the measurement system acquires an average image. The parallax image generator 30 of the measurement system 10 acquires the average image Gmean generated using the non-polarized pixels in the stereo mixed image generated in step ST22, and then, the process proceeds to step ST25.

In step ST25, the measurement system acquires a 90-degree polarized image. The parallax image generator 30 of the measurement system 10 performs the calculation of Equation (13) using the pixel value I₀ of the ordinary ray image Go acquired in step ST23 and the pixel value Iₘₑₐₙ of the average image Gmean acquired in step ST24 and calculates the pixel value Iₑ of the 90-degree polarized image, that is, the extraordinary ray image Ge, and then, the process proceeds to step ST26.

[Math. 9]

I₉₀=2×Iₘₑₐₙ−I₀ (13)

In step ST26, the measurement system performs corresponding point matching. The distance measuring unit 40 of the measurement system 10 performs corresponding point matching using the 0-degree polarized image (ordinary ray image) that is an image from one viewpoint acquired in step ST23, and the 90-degree polarized image (extraordinary ray image) that is an image from the other viewpoint acquired in step ST25 and calculates the positional difference ∥PoPe∥ between the distance measurement position Po in the ordinary ray image and the distance measurement position Pe in the extraordinary ray image, and then, the process proceeds to step ST27.

The measurement system calculates the distance in step ST27. The distance measuring unit 40 of the measurement system performs calculation of Equation (1) using the focal distance f and the baseline length B set in advance and the parallax ∥PoPe∥ calculated in step ST26 and calculates the distance Z(P) to the distance measurement position P.

The measurement system may acquire a 90-degree polarized image in step ST23 and calculate a 0-degree polarized image in step ST25, the 0-degree polarized image may be an extraordinary ray image and the 90-degree polarized image may be an ordinary ray image.

As described above, according to the second embodiment, similar to the first embodiment, distance information with higher resolution than when edge images are used can be obtained. The number of polarization directions of the polarized pixels can be reduced compared to the first embodiment.

### 4. CONFIGURATION AND OPERATION OF THIRD EMBODIMENT

Next, a third embodiment will be described. In the first embodiment and the second embodiment described above, the case in which the polarized imaging unit 25 is configured using polarized pixels whose polarization directions are orthogonal to each other, and the case in which the polarized imaging unit 25 is configured using polarized pixels having one polarization direction and non-polarized pixels have been described. In the third embodiment, a case in which the polarized imaging unit 25 is configured using three or more types of polarized pixels will be described.

When a polarizing plate is installed perpendicular to the observation direction and the partially polarized light is observed through the polarizing plate, the luminance of the transmitted light changes each time the polarizing plate is rotated. Here, when the polarizing plate is rotated, the highest luminance is Imax and the lowest luminance is Imin, and a two-dimensional coordinate system (x-axis and y-axis) is defined on the plane of the polarizing plate, the polarization angle u, which is the angle when the polarizing plate is rotated is defined as the angle between the polarization axis of the polarizing plate and the x-axis and is expressed as the angle from the x-axis to the y-axis. The polarization axis is an axis representing the direction in which light is polarized after passing through the polarizing plate. When the polarizing plate is rotated, the polarization direction has a periodicity of 180°, and the polarization angle takes values from 0° to 180°. Here, it is known that, if the polarization angle θpol when the maximum luminance Imax is observed is defined as the phase angle φ, the luminance I observed when the polarizing plate is rotated can be represented by a polarization model illustrated in Equation (14).

Equation (14) can be converted to Equation (15). When the observed value (luminance) of the polarized pixel with a polarization direction of 0° is “I0”, the observed value (luminance) of the polarized pixel with a polarization direction of 45° is “I1”, the observed value (luminance) of the polarized pixel with a polarization direction of 90° is “I2”, and the observed value (luminance) of the polarized pixel with a polarization direction of 135° is “I3”, the coefficient a in Equation (15) is the value illustrated in Equation (16). The coefficients b and c in Equation (15) are values illustrated in Equations (17) and (18). Note that Equation (18) represents the average image described above.

$$[ Math . 10 ]$$

$$I = \frac{{I}_{max} + {1}_{min}}{2} + \frac{{I}_{max} - {I}_{min}}{2} cos ( 2 {θ}_{pol} - 2 ϕ ) \qquad ( 14 )$$

$$I = a \cdot sin ( 2 \cdot θ ) + b \cdot cos ( 2 \cdot θ ) + c \qquad ( 15 )$$

$$a = \frac{{I}_{1} - {I}_{3}}{2} \qquad ( 16 )$$

$$b = \frac{{I}_{0} - {I}_{2}}{2} \qquad ( 17 )$$

$$c = \frac{{I}_{0} + {I}_{1} + {I}_{2} + {I}_{3}}{4} \qquad ( 18 )$$

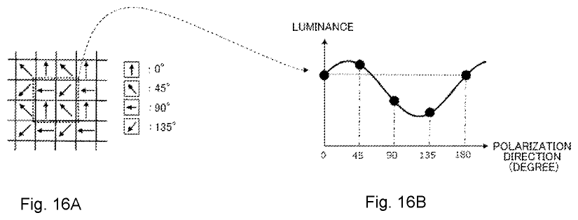

FIG. 16 illustrates the relationship between the polarization direction and the pixel value of the polarized pixel. FIG. 16(a) illustrates the pixel configuration of the polarized imaging unit 25 which is composed of polarized pixels with the polarization directions of 0, 45, 90, and 135°. FIG. 16(b) illustrates pixel values (luminance) in a polarized pixel block composed of polarized pixels of 2×2 pixels.

In the third embodiment, a case in which an ordinary ray image and an extraordinary ray image are generated as parallax images from a polarization model based on pixel values of three or more polarized pixels will be described.

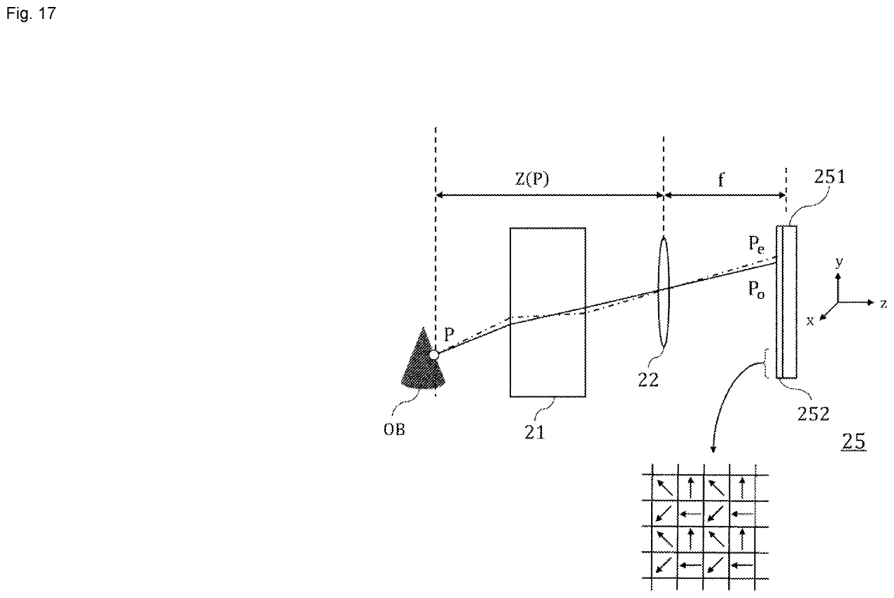

FIG. 17 illustrates the configuration of the third embodiment, in which the polarized imaging unit 25 includes a polarized pixel with a polarization direction of 0°, a polarized pixel with a polarization direction of 45°, a polarized pixel with a polarization direction of 90°, and a polarized pixel with a polarization direction of 135°. In the third embodiment, the baseline length B and the focal length f are measured in advance, as in the first and second embodiments.

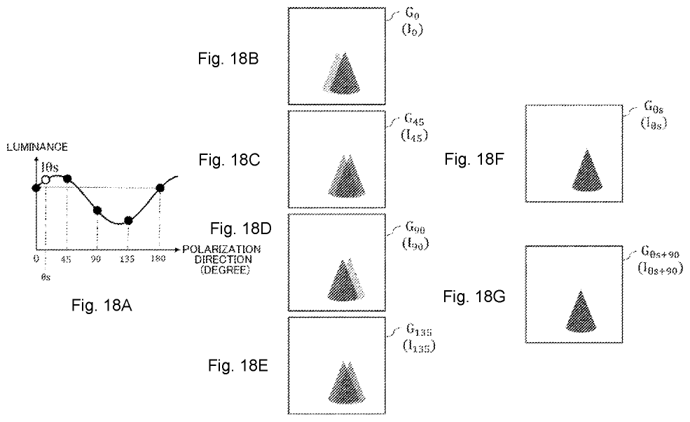

The parallax image generator 30 calculates the polarization model represented by Equation (14) or (15) for each pixel using the pixel values of the polarized image for each polarization direction, and obtains the clearest parallax image. FIG. 18 illustrates images generated by the parallax image generator. FIG. 18(a) illustrates the relationship between the polarization direction and the luminance. Note that the polarization direction θs is the polarization direction in which the polarized image becomes the clearest. FIG. 18(b) illustrates a 0-degree polarized image G₀ generated using polarized pixels whose polarization direction is 0°, FIG. 18(c) illustrates a 45-degree polarized image G₄₅ generated using polarized pixels whose polarization direction is 45°, FIG. 18(d) illustrates a 90-degree polarized image G₉₀ generated using polarized pixels whose polarization direction is 90°, and FIG. 18(e) illustrates a 135-degree polarized image G₁₃₅ generated using polarized pixels whose polarization direction is 135°. The pixel value of the 0-degree polarized image G₀ is the pixel value I₀, the pixel value of the 45-degree polarized image G₄₅ is the pixel value I₄₅, the pixel value of the 90-degree polarized image G₉₀ is the pixel value I₉₀, and the pixel value of the 135-degree polarized image G₁₃₅ is the pixel value I₁₃₅.

The parallax image generator 30 generates a polarized image G_{θs}, in the clearest polarization direction illustrated in FIG. 18(f) and a polarized image G_{θs+90} illustrated in FIG. 18(g), whose polarization direction has a phase difference of 90° from the polarized image as parallax images. The polarized image G_{θs} has a pixel value I_{θs}, and the polarized image G_{θs+90} has a pixel value I_{θs+90}.

The distance measuring unit 40 performs corresponding point matching processing using the parallax images generated by the parallax image generator 30, and calculates the parallax of the distance measurement position P. The distance measuring unit 40 calculates the distance Z(P) to the distance measurement position P on the subject OB based on the calculated parallax.

Next, the operation of the third embodiment will be explained. The baseline length B and focal length f are measured in advance. By using three or more types of polarized pixels with different polarization directions, since it is possible to estimate the pixel value in a desired polarization direction as described later, it is not necessary to perform the processing of matching the polarizing filter with the y-axis direction of the birefringent material in the calibration.

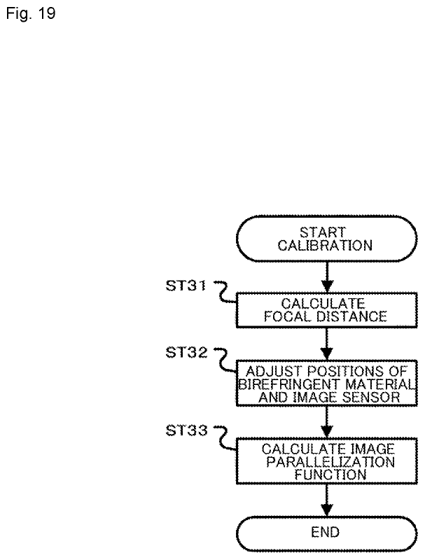

FIG. 19 is a flowchart illustrating the calibration operation in the third embodiment.

In step ST31, the measurement system calculates the focal length. The measurement system 10 performs the same processing as the conventional calibration method or step ST1 in FIG. 7, performs calibration using internal parameters, and calculates the focal length f, and then, the process proceeds to step ST32.

In step ST32, the measurement system adjusts the positions of the birefringent material and the image sensor. The measurement system 10 adjusts the positions of the birefringent material and the image sensor so that the z-axis (optical axis) of the birefringent material is perpendicular to the imaging surface of the image sensor of the polarized imaging unit, and then, the process proceeds to step ST33.

In step ST33, the measurement system calculates an image parallelization function. The measurement system 10 calculates an image parallelization function T that converts the polarized image generated by the birefringence imaging unit 20 into a stereo mixed image obtained by mixing right-viewpoint images and left-viewpoint images. The image parallelization function T is calculated using the method described in NPL 2, for example.

After performing the calibration of FIG. 19, the measurement system 10 performs the distance measurement operation for the measurement target.

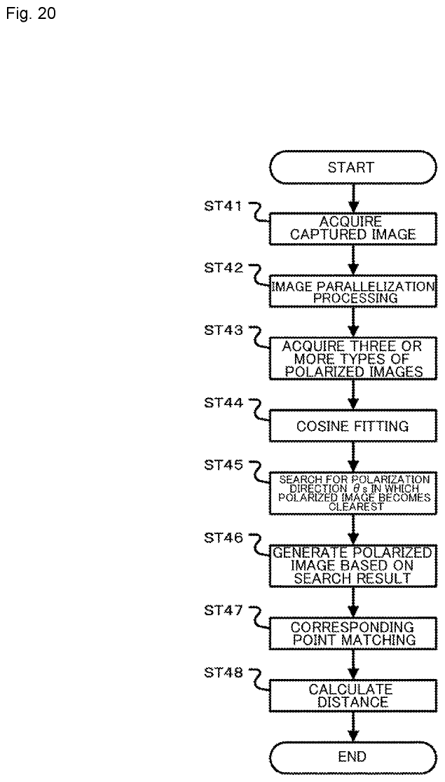

FIG. 20 is a flowchart illustrating the operation of the third embodiment. In step ST41, the measurement system acquires a captured image. The birefringence imaging unit 20 of the measurement system 10 performs imaging so that the distance measurement position P of the measurement target subject OB is within the angle of view, and acquires a polarized image, and then, the process proceeds to step ST42.

In step ST42, the measurement system performs image parallelization processing. The parallax image generator 30 of the measurement system 10 performs image parallelization processing on the polarized image acquired by the birefringence imaging unit 20 using the image parallelization function T calculated by calibration, and ordinary ray image and extraordinary ray image to convert the polarized image into a stereo mixed image in which the ordinary ray image and the extraordinary ray image are images from the right viewpoint and the left viewpoint, and the distance measurement position has a parallax according to the distance, and then, the process proceeds to step ST43.

In step ST43, the measurement system acquires three or more types of polarized images. The parallax image generator 30 of the measurement system 10 acquires polarized images for each of three or more polarization directions from the stereo mixed image generated in step ST42. For example, if the polarized imaging unit 25 has a polarized pixel with a polarization direction of 0°, a polarized pixel with a polarization direction of 45°, a polarized pixel with a polarization direction of 90°, and a polarized pixel with a polarization direction of 135°, the parallax image generator 30 acquires a polarized image generated using a polarized pixel with a polarization direction of 0°. The parallax image generator 30 generates a polarized image generated using polarized pixels having a polarization direction of 45°, a polarized image generated using polarized pixels having a polarization direction of 90°, and a polarized image generated using polarized pixels having a polarization direction of 135°, and then, the process proceeds to step ST44.

In step ST44, the measurement system performs cosine fitting. The parallax image generator 30 of the measurement system 10 calculates a polarization model for each polarized pixel block using the pixel values of the polarized image for each polarization direction. When the pixel value of the polarized image for each polarization direction for each pixel is obtained by interpolation processing, the parallax image generator 30 calculates the polarization model for each pixel, and then, the process proceeds to step ST45.

In step ST45, the measurement system searches for a polarization direction in which the polarized image becomes the clearest. In the first search method for searching for the polarization direction in which the polarized image becomes the clearest, the parallax image generator 30 of the measurement system 10 performs calculation of Equation (19) using a function e for edge extraction such as the Sobel method, the Laplacian method, or the Canny method. The parallax image generator 30 sets the angle β at which the evaluation value H indicating the minimum edge component is obtained as the polarization direction θs in which the polarized image becomes the clearest, that is, the polarization direction θs in which a polarized image in which an extraordinary ray image is least mixed with the ordinary ray image or an ordinary ray image is least mixed with the extraordinary ray image is obtained. In Equation (19), e(I_{β})ᵢ the pixel value (luminance) of the i-th pixel in the edge image. “1 to K” indicates a predetermined image range used for searching the polarization direction, and the predetermined image range may be the entire screen region, and may be an image range that is set in advance so as to include the measurement target subject.

$$[ Math . 11 ]$$

$$H = {min}_{0 \leq β < 180} {\sum }_{i = 0}^{K} {e ( {I}_{β} )}_{i} \qquad ( 19 )$$

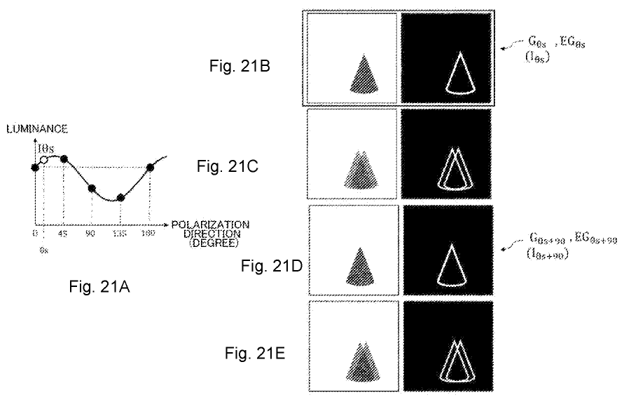

FIG. 21 is a diagram illustrating the first search method. FIG. 21(a) illustrates the relationship between the polarization direction and luminance. FIG. 21(b) illustrates the polarized image G_{θs}, and the edge image EG_{θs} in the polarization direction θs in which the polarized image is the clearest, and the polarized image G_{θs}, corresponds to, for example, the ordinary ray image Go.

FIG. 21(c) illustrates a case in which the angle is larger than the polarization direction θs. In this case, since the angle is larger than the polarization direction θs, the ordinary ray image includes the extraordinary ray image, and the edge component increases more than the edge image EG_{θs} illustrated in FIG. 21(b). FIG. 21(d) illustrates a case in which the angle is 90° larger than the polarization direction θs. In this case, since the angle is 90° larger than the polarization direction θs, the polarized image becomes an extraordinary ray image, and the edge component is reduced as compared with FIG. 21(b). FIG. 21(d) illustrates a case in which the angle is larger than the polarization direction θs+90. In this case, since the angle is larger than the polarization direction θs+90, the extraordinary ray image includes the ordinary ray image, and the edge component increases compared to FIG. 21(c).

In this way, the parallax image generator 30 sets the polarization direction θs in which the polarized image becomes the clearest as the polarization direction in which the edge component is minimized.

Alternatively, the parallax image generator 30 may search for the clearest polarized image in the polarization direction using another search method. In the second search method, search is performed using polarized images in which the polarization directions have a phase difference of 90°. In the second search method, the parallax image generator 30 calculates the difference value |I_{β}−I_{β-90} using the pixel value I_{β} of the polarized image in the polarization direction β and the pixel value I_{β-90} of the polarized image in the polarization direction (β−90). In two polarized images whose polarization directions have a phase difference of 90°, the difference value is maximized if the ordinary ray image (extraordinary ray image) does not include the extraordinary ray image (ordinary ray image), and the difference value decreases as the ordinary ray image (extraordinary ray image) is included in the extraordinary ray image (ordinary ray image). Therefore, the parallax image generator 30 performs the calculation illustrated in Equation (20), and the angle β at which the evaluation value H indicating the sum of the differences for each pixel in a predetermined image range of the polarized images whose polarization directions have a phase difference of 90° is maximized is set as the polarization direction θs at which the polarized image becomes the clearest.

$$[ Math . 12 ]$$

$$H = {max}_{0 \leq β < 180} {\sum }_{i = 0}^{K} {\vert {I}_{β} - {I}_{β - 90} \vert}_{i} \qquad ( 20 )$$

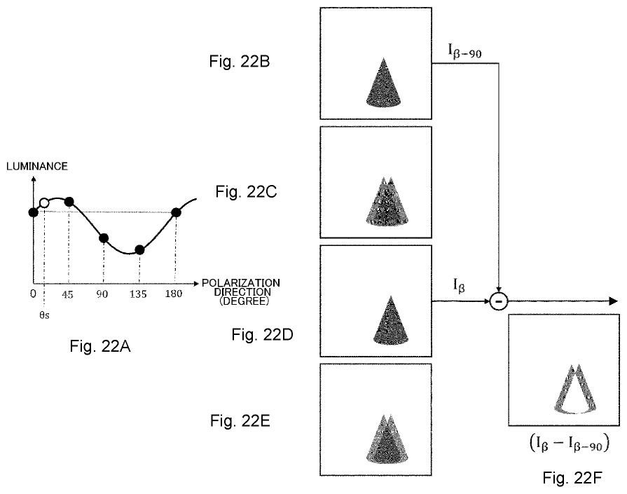

FIG. 22 is a diagram illustrating the second search method. FIG. 22(a) illustrates the relationship between the polarization direction and luminance. FIG. 22(b) illustrates a polarized image in the polarization direction (β−90), and FIG. 22(d) illustrates a polarized image in the polarization direction β. Note that the polarized image in the polarization direction β corresponds to, for example, the ordinary ray image Go.

FIG. 22(c) illustrates a case in which the angle is smaller than the polarization direction β. In this case, since the angle is smaller than the polarization direction β, the ordinary ray image includes the extraordinary ray image, and the difference value is reduced as compared with FIG. 22(d). FIG. 22(e) illustrates a case in which the angle is larger than the polarization direction β. In this case, since the angle is larger than the polarization direction β, the ordinary ray image includes the extraordinary ray image, and the difference value is reduced as compared with FIG. 22(d).

In this way, the parallax image generator 30 sets the polarization direction β in which the difference between the polarized images whose polarization directions have a phase difference of 90° is maximized as the polarization direction θs in which the polarized image becomes the clearest.

Since the polarized image in the polarization direction in which the image becomes clear has a phase difference of 90°, the parallax image generator 30 may perform the calculation illustrated in Equation (21), and the angle having a phase difference of 45° from the angle β at which the evaluation value H indicating the sum of the differences for each pixel in a predetermined image range of the polarized images whose polarization directions have a phase difference of 90° is minimized may be set as the polarization direction θs at which the polarized image becomes the clearest.

$$[ Math . 13 ]$$

$$H = {min}_{0 \leq β < 180} {\sum }_{i = 0}^{K} {\vert {I}_{β} - {I}_{β - 90} \vert}_{i} \qquad ( 21 )$$

Next, as a third method, search may be performed using three polarized images whose polarization directions have a phase difference of 45°. In the third method, the parallax image generator 30 performs calculation illustrated in Equation (22) using a pixel value I_{β} of the polarized image in the polarization direction β, a pixel value I_{β+45} of the polarized image in the polarization direction (β+45), and a pixel value I_{β-90} of the polarized image in the polarization direction (β−90), and a polarization direction β in which the evaluation value H indicating the sum of differences in a predetermined image range between an added image of the polarized images whose polarization directions have a phase difference of 90° and a polarized image having a phase difference of 45° is minimized is set as the polarization direction θs in which the polarized image becomes the clearest.

$$[ Math . 14 ]$$

$$H = {min}_{0 \leq β < 180} {\sum }_{i = 0}^{K} {\vert {I}_{β} + {I}_{β - 90} - {I}_{β + 45} \vert}_{i} \qquad ( 22 )$$

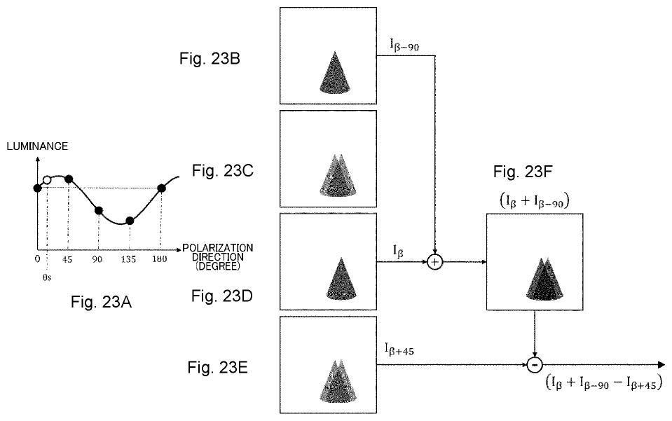

FIG. 23 is a diagram illustrating the third search method. FIG. 23(a) illustrates the relationship between the polarization direction and luminance. FIG. 23(b) illustrates a polarized image in the polarization direction (β−90), and FIG. 23(d) illustrates a polarized image in the polarization direction β. Note that the polarized image in the polarization direction β corresponds to, for example, the ordinary ray image Go. FIG. 23(c) illustrates a case in which the angle is smaller than the polarization direction β. In this case, since the angle is smaller than the polarization direction β, the ordinary ray image includes the extraordinary ray image. FIG. 23(e) illustrates a polarized image in the polarization direction (β+45), which is an image in which an extraordinary ray image is included in an ordinary ray image.

The parallax image generator 30 adds the pixel value I_{β} of the polarized image in the polarization direction β and the pixel value I_{β-90} of the polarized image in the polarization direction (β−90) to generate an added image representing the ordinary ray image and the extraordinary ray image. The parallax image generator 30 subtracts the pixel value I_{β+45} of the polarized image in the polarization direction (β+45) from the pixel value of the added image.

The parallax image generator 30 sets the polarization direction β in which the difference between the added image and the polarized image in the polarization direction (β+45) is minimized as the polarization direction θs in which the polarized image becomes the clearest.

Next, as a fourth method, the parallax image generator 30 performs search using three polarized images whose polarization directions have a phase difference of 45°. In the fourth method, the parallax image generator 30 performs calculation illustrated in Equation (23) using the pixel value I_{β} of the polarized image in the polarization direction 8, the pixel value I_{β-45} of the polarized image in the polarization direction (β−45), and the pixel value I_{β-90} of the polarized image in the polarization direction (β−90), and the polarization direction β in which the evaluation value H indicating the sum of differences in a predetermined image range between the added image of the polarized images whose polarization directions have a phase difference of 90° and a polarized image having a phase difference of 45° is minimized is set as the polarization direction θs in which the polarized image becomes the clearest.

$$[ Math . 15 ]$$

$$H = {min}_{0 \leq β < 180} {\sum }_{i = 0}^{K} {\vert {1}_{β - 45} - {I}_{β} - {I}_{β - 90} \vert}_{i} \qquad ( 23 )$$

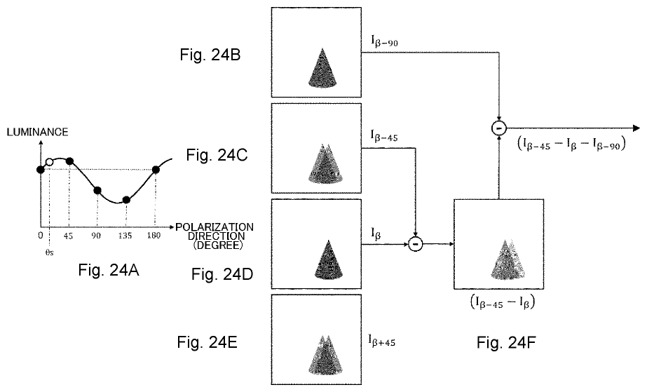

FIG. 24 is a diagram illustrating the fourth search method. FIG. 24(a) illustrates the relationship between the polarization direction and luminance. FIG. 24(b) illustrates a polarized image in the polarization direction (β−90), and FIG. 24(d) illustrates a polarized image in the polarization direction β. Note that the polarized image in the polarization direction β corresponds to, for example, the ordinary ray image Go.

FIG. 24(c) illustrates a polarized image in the polarization direction (β−45), and FIG. 24(e) illustrates a polarized image in the polarization direction (β+45), in which the polarized image is an image including an ordinary ray image and an extraordinary ray image.

The parallax image generator 30 subtracts the pixel value I_{β} of the polarized image in the polarization direction β from the pixel value I_{β-45} of the polarized image in the polarization direction (β−45), and generates a difference image in which the ordinary ray image is attenuated in the image including the ordinary ray image and the extraordinary ray image. The parallax image generator 30 subtracts the pixel value I_{β-90} of the polarized image in the polarization direction (β−90) from the pixel value of the difference image.

The parallax image generator 30 sets the polarization direction β in which the difference between the difference image and the polarized image in the polarization direction (β−90) is minimized as the polarization direction θs in which the polarized image becomes the clearest.

The parallax image generator 30 searches for a polarization direction in which the polarized image becomes the clearest based on any one of the first to fourth search methods, and then, the process proceeds to step ST46. The parallax image generator 30 may use another search method if the polarization direction cannot be searched by any one of the first to fourth search methods and may determine the polarization direction in which the polarized image becomes the clearest using the search results of a plurality of search methods.

In step ST46, the measurement system generates a polarized image based on the search result. The parallax image generator 30 of the measurement system 10 generates the polarized image in the polarization direction θs searched in step ST45 and the polarized image in the polarization direction (θs+90) or the polarization direction (θs−90) based on Equation (14) or (15), and then, the process proceeds to step ST47.

In step ST47, the measurement system performs corresponding point matching. The distance measuring unit 40 of the measurement system 10 performs corresponding point matching using the polarized image in the polarization direction θs generated in step ST46 (corresponding to one of the ordinary ray image and the extraordinary ray image) and the polarized image in the polarization direction (θs+90) or the polarization direction (θs−90) (corresponding to the other of the ordinary ray image and the extraordinary ray image), and calculates the positional difference ∥PoPe∥ between the position Po of the distance measurement target in the ordinary ray image and the position Pe of the distance measurement target in the extraordinary ray image, and then, the process proceeds to step ST48.

The measurement system calculates the distance in step ST48. The distance measuring unit 40 of the measurement system performs calculation of Equation (1) using the focal distance f and the baseline length B set in advance and the parallax ∥PoPe∥ calculated in step ST45 and calculates the distance Z(P) to the distance measurement position P.

As described above, according to the third embodiment, as in the first and second embodiments, corresponding point matching can be performed even in a portion where no edge is detected, and distance information with higher resolution than when edge images are used can be obtained. High-resolution distance information can be obtained based on the polarization characteristics of the subject.

### 5. MODIFICATION EXAMPLES

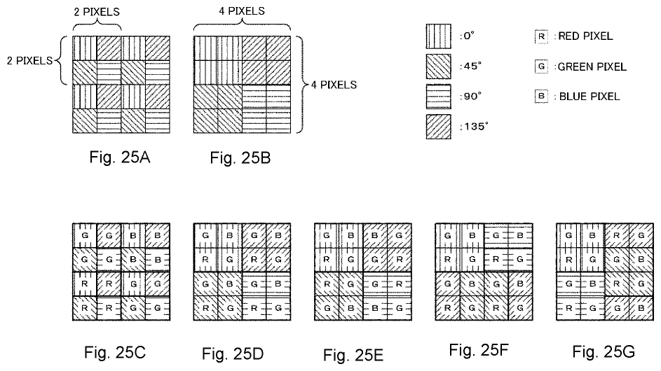

The pixel configuration of the polarized imaging unit is not limited to the configurations of the first to third embodiments, and may be the configurations of FIGS. 25, 26, and 27, and the configurations illustrated in the figures are repeated in the horizontal and vertical directions. FIGS. 25(a) and 25(b) illustrate the pixel configuration when obtaining a black-and-white image. Note that FIG. 25(a) illustrates a case in which a polarized pixel block of 2×2 pixels is composed of polarized pixels with polarization directions (polarization angles) of, for example, 0, 45, 90, and 135°. FIG. 25(b) illustrates a case in which a polarized pixel block of 4×4 pixels with 2×2 pixels as a unit pixel in the polarization direction is composed of polarized pixels with polarization directions of, for example, 0, 45, 90, and 135°. When the polarization component unit of the polarizing filter is 2×2 pixels as illustrated in FIG. 25(b), the ratio of leakage of the polarization component from adjacent regions of different polarization component units with respect to the polarization component obtained for each polarization component unit is smaller than that of the 1×1 pixels illustrated in FIG. 25(a). When the polarizing filter uses a wire grid, polarized light whose electric field component is perpendicular to the direction of the grid (wire direction) is transmitted, and the longer the wire, the higher the transmittance. Therefore, when the polarization component unit is 2×2 pixels, the transmittance is higher than that of 1×1 pixels. Therefore, when the polarization component unit is 2×2 pixels, the transmittance is higher than that of 1×1 pixels, and the extinction ratio can be improved.

FIGS. 25(c) to 25(g) illustrate the pixel configuration when obtaining a color image. FIG. 25(c) illustrates a case in which the polarized pixel block of 2×2 pixels illustrated in FIG. 25(a) is used as one color unit, and the three primary color pixels (red, green and red pixels) are arranged in the Bayer array.

FIG. 25(d) illustrates a case in which the three primary color pixels are arranged in the Bayer array for each pixel block of 2×2 pixels having the same polarization direction illustrated in FIG. 25(b).

FIG. 25(e) illustrates a case in which three primary color pixels are arranged in the Bayer array for each pixel block of 2×2 pixels having the same polarization direction, and the 2×2 pixel blocks having different polarization directions are pixels of the same color.

FIG. 25(f) illustrates a case in which, for pixel blocks of 2×2 pixels in the same polarization direction and arranged in the Bayer array, the phase difference in the polarization direction of pixel blocks adjacent in the horizontal direction is 90°, and the phase difference in the polarization direction of pixel blocks adjacent in the vertical direction is ±45°.

FIG. 25(g) illustrates a case in which, for pixel blocks of 2×2 pixels in the same polarization direction and arranged in the Bayer array, the phase difference in the polarization direction of pixel blocks adjacent in the vertical direction is 90°, and the phase difference in the polarization direction of pixel blocks adjacent in the horizontal direction is ±45°.

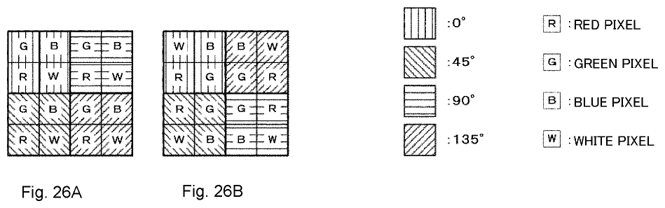

FIG. 26 illustrates a case in which three primary color pixels and white pixels are provided. For example, FIG. 26(a) illustrates a case in which one green pixel in pixel blocks of 2×2 pixels in the same polarization direction and arranged in the Bayer arrangement illustrated in FIG. 25(d) is a white pixel.

FIG. 26(b) illustrates a case in which one green pixel in pixel blocks of 2×2 pixels in the same polarization direction and arranged in the Bayer arrangement illustrated in FIG. 25(e) is a white pixel, and block of 2×2 pixels with different polarization directions have pixels of the same color.

By providing white pixels in this way, as disclosed in the Patent Literature “WO 2016/136085”, the dynamic range in generating normal line information can be expanded as compared to the case in which white pixels are not provided. Since the white pixels have a good S/N ratio, the calculation of the color difference is less susceptible to noise.

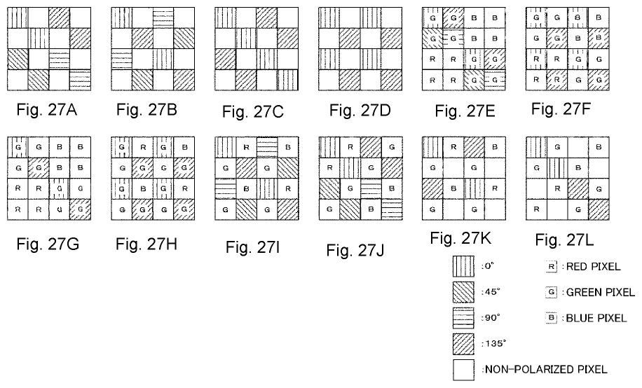

FIG. 27 illustrates a case in which non-polarized pixels are provided, in which FIGS. 27(a) to 27(d) illustrate a case of obtaining black-and-white images and FIGS. 27(e) to 27(l) illustrate a case of obtaining color images. The illustrations of the polarization directions and color pixels are the same as those in FIG. 25.

FIG. 27(a) illustrates a case in which, in the pixel blocks of 2×2 pixels having the same polarization direction illustrated in FIG. 25(b), polarized pixels positioned in a diagonal direction are non-polarized pixels.

FIG. 27(b) illustrates a case in which polarized pixels having a phase difference of 45° are provided in a pixel block of 2×2 pixels in a diagonal direction, and the polarized pixels have a phase difference of 90° from adjacent pixel blocks.

FIG. 27(c) illustrates a case in which polarized pixels having the same polarization direction are provided in a pixel block of 2×2 pixels in a diagonal direction, the polarized pixels have a phase difference of 45° from adjacent pixel blocks, and the polarization directions of the polarized pixels are two directions having a phase difference of 45°. It should be noted that the acquisition of polarization information from non-polarized pixels and polarized pixels with two polarization directions may be performed using, for example, the technique disclosed in Patent Literature “WO 2018/074064”.

FIG. 27(d) illustrates a case in which polarized pixels having a phase difference of 45° are provided in a pixel block of 2×2 pixels in a diagonal direction, and the polarization directions of the polarized pixels are two directions having a phase difference of 45°.

FIG. 27(e) illustrates a case in which a pixel block of 4×4 pixels is formed using two pixel blocks of 2×2 pixels having four different polarization directions and two pixel blocks of 2×2 pixels composed of non-polarized pixels, a pixel block of polarized pixels is green pixels, a pixel block of non-polarized pixels is red pixels or blue pixels, and pixel blocks (2×2 pixels) of the same color are arranged in the Bayer array.

FIG. 27(f) illustrates a case in which polarized pixels are arrange in the same manner as in FIG. 27(d), a pixel block composed of two polarized images with different polarization directions and two non-polarized pixels is used as a color unit, and pixel blocks of the three primary colors are arranged as the Bayer array.

FIG. 27(g) illustrates a case in which a pixel block of 2×2 pixels is used as a color unit, pixel blocks of the three primary colors are arranged in the Bayer array, and polarized pixels with two different polarization directions are provided in a pixel block of green pixels.

FIG. 27(h) illustrates a case in which polarized pixels are provided in the same manner as in FIG. 27(d), a pixel block composed of two polarized pixels with different polarization directions and two non-polarized pixels is composed of three green pixels and one non-polarized red pixel, and one non-polarized pixel is a blue pixel in adjacent pixel blocks

FIGS. 27(i) and 27(j) illustrate a case in which non-polarized pixels are used as color pixels and pixels of three primary colors are provided in a pixel block of 4×4 pixels. FIGS. 27(k) and 27(l) illustrate a case in which some non-polarized pixels are used as color pixels and three primary color pixels are provided in a pixel block of 4×4 pixels.

Note that the configurations illustrated in FIGS. 25 to 27 are examples, and other configurations may be used. In order to enable high-sensitivity imaging even at night, for example, a configuration in which infrared (IR) pixels are mixed and repeated may be used.

With such a pixel configuration, the distance to the distance measurement position can be measured based on the polarized image, and the polarization characteristics of each pixel can be obtained. A non-polarized color image can be obtained.

### 5. APPLICATION EXAMPLES

The technology according to the present disclosure can be applied to various fields. For example, the technology according to the present disclosure may be realized as a device equipped in any type of moving body such as an automobile, an electric vehicle, a hybrid electric vehicle, a motorcycle, a bicycle, a personal mobility device, an airplane, a drone, a ship, and a robot. The technology may be realized as a device mounted in equipment that is used in a production process in a factory or equipment that is used in a construction field.

If applied to such a field, it is possible to obtain high-resolution distance information even for a subject with few edges without using a plurality of imaging devices. Therefore, the surrounding environment can be grasped three-dimensionally with high accuracy, and fatigue of drivers and workers can be reduced. Automated driving and the like can be performed more safely.

A series of processes described in the specification can be executed by hardware, software, or a composite configuration of both. When executing processing by software, a program recording a processing sequence is installed in a memory within a computer incorporated in dedicated hardware and executed. Alternatively, the program can be installed and executed in a general-purpose computer capable of executing various processes. For example, the program can be recorded in advance in a hard disk, SSD (Solid State Drive), or ROM (Read Only Memory) as a recording medium. Alternatively, the program can be temporarily or permanently stored (recorded) in a removable recording medium such as a flexible disk, a CD-ROM (Compact Disc Read Only Memory), a MO (Magneto optical) disk, a DVD (Digital Versatile Disc), a BD (Blu-Ray Disc (registered trademark)), a magnetic disk, and a semiconductor memory card. Such a removable recording medium can be provided as so-called package software.

The program may be transferred from a download site to the computer wirelessly or by wire via a network such as a local area network (LAN) or the Internet, in addition to being installed in the computer from the removable recording medium. The computer can receive the program transferred in this way and install the program in a recording medium such as a built-in hard disk.

The effects described in the present specification are merely examples and are not limited, and there may be additional effects not described. The present technology should not be construed as being limited to the embodiments of the technology described above. The embodiments of the present technology disclose the present technology in the form of examples, and it is obvious that a person skilled in the art can modify or substitute the embodiments without departing from the gist of the present technique. That is, claims should be taken into consideration in order to determine the gist of the present technology.

The signal processing device of the present technology can also have the following configuration.
(1) A signal processing device including:
a polarized imaging unit that generates polarized images based on subject light incident through a birefringent material;
a parallax image generator that separates images with different polarization angles using the polarized images generated by the polarized imaging unit and generates an ordinary ray image and an extraordinary ray image as parallax images; and
a distance measuring unit that calculates a distance to a distance measurement position based on a parallax of the distance measurement position of the subject in the ordinary ray image and the extraordinary ray image generated by the parallax image generator.
(2) The signal processing device according to (1), wherein
the polarized imaging unit has an imaging surface perpendicular to an optical axis of the birefringent material.
(3) The signal processing device according to (2), wherein
the polarized imaging unit is provided with polarized pixels whose polarization directions have a phase difference of 90°, and the polarization directions match a horizontal direction and a vertical direction of the birefringent material, and
the parallax image generator generates the ordinary ray image using a polarized pixel whose polarization direction matches one of the horizontal direction and the vertical direction of the birefringent material, and generates the extraordinary ray image using a polarized pixel whose polarization direction matches the other direction.
(4) The signal processing device according to (2), wherein
the polarized imaging unit is configured using polarized pixels having a predetermined polarization direction and non-polarized pixels that are non-polarized, and the polarization direction matches the horizontal direction or the vertical direction of the birefringent material, and
the parallax image generator generates one of the ordinary ray image and the extraordinary ray image using the polarized pixels, and generates the other image based on an image generated using the polarized pixels and an image generated using the non-polarized pixels.
(5) The signal processing device according to (2), wherein
the polarized imaging unit is configured using polarized pixels having three or more different polarization directions, and
the parallax image generator calculates a polarization model based on pixel values of the polarized pixels having three or more different polarization directions and generates the parallax image based on the calculated polarization model.
(6) The signal processing device according to (5), wherein
the parallax image generator searches for a polarization direction in which the other image included in one of the ordinary ray image and the extraordinary ray image is minimized, and generates an image having a phase difference of 90° from the image of the searched polarization direction as the parallax image.
(7) The signal processing device according to (6), wherein
the parallax image generator searches for a polarization direction in which an edge component of the polarized image based on the polarization model is minimized.
(8) The signal processing device according to (6) or (7), wherein
the parallax image generator searches for one polarization direction of two polarized images based on the polarization model, in which a sum of differences for each pixel of the two polarized images whose polarization directions have a phase difference of 90° is maximized.
(9) The signal processing device according to any one of (6) to (8), wherein
the parallax image generator searches for a polarization direction having a phase difference of 45° from one polarization direction of two polarized images based on the polarization model, in which a sum of differences for each pixel of the two polarized images whose polarization directions have a phase difference of 90° is minimized.
(10) The signal processing device according to any one of (6) to (9), wherein
the parallax image generator searches for one polarization direction of two polarized images based on the polarization model, in which a sum of differences for each pixel between an added image of two polarized images whose polarization directions have a phase difference of 90° and a polarized image having a phase difference of 45° is minimized.
(11) The signal processing device according to any one of (2) to (10), wherein
the parallax image generator generates an ordinary ray image and an extraordinary ray image having a parallax in a horizontal direction as parallax images using a predetermined image parallelization function.

The present technology includes the following imaging devices.
(1) An imaging device in which a birefringent material is provided so that an optical axis is perpendicular to an imaging surface, and
the imaging surface on which subject light is incident through the birefringent material has a pixel configuration capable of generating a polarized image having one polarization direction and a non-polarized image, a polarized image for each of a plurality of different polarization directions and a non-polarized image, or a polarized image for each of three or more different polarization directions.
(2) The imaging device according to (1), wherein when there is one polarization direction, the polarization direction matches a polarization direction of an ordinary ray of the birefringent material or a polarization direction of an extraordinary ray of the birefringent material.
(3) The imaging device according to (1), wherein when there are two polarization directions, one of the polarization directions matches the polarization direction of the ordinary ray of the birefringent material and the other polarization direction matches the polarization direction of the extraordinary ray of the birefringent material.

### REFERENCE SIGNS LIST

10 Measuring system
20 Birefringence imaging unit
21 Birefringent material
22 Imaging optical system
25 Polarized imaging unit
30 Parallax image generator
40 Distance measuring unit
50 Checkerboard
51 Polarizing plate
251 Image sensor
252 Polarizing filter

1. A signal processing device comprising:
a polarized imaging unit that generates polarized images based on subject light incident through a birefringent material;
a parallax image generator that separates images with different polarization angles using the polarized images generated by the polarized imaging unit and generates an ordinary ray image and an extraordinary ray image as parallax images; and
a distance measuring unit that calculates a distance to a distance measurement position based on a parallax of the distance measurement position of the subject in the ordinary ray image and the extraordinary ray image generated by the parallax image generator.

2. The signal processing device according to claim 1, wherein the polarized imaging unit has an imaging surface perpendicular to an optical axis of the birefringent material.

3. The signal processing device according to claim 2, wherein
the polarized imaging unit is provided with polarized pixels whose polarization directions have a phase difference of 90°, and the polarization directions match a horizontal direction and a vertical direction of the birefringent material, and
the parallax image generator generates the ordinary ray image using a polarized pixel whose polarization direction matches one of the horizontal direction and the vertical direction of the birefringent material, and generates the extraordinary ray image using a polarized pixel whose polarization direction matches the other direction.

4. The signal processing device according to claim 2, wherein
the polarized imaging unit is configured using polarized pixels having a predetermined polarization direction and non-polarized pixels that are non-polarized, and the polarization direction matches the horizontal direction or the vertical direction of the birefringent material, and
the parallax image generator generates one of the ordinary ray image and the extraordinary ray image using the polarized pixels, and generates the other image based on an image generated using the polarized pixels and an image generated using the non-polarized pixels.

5. The signal processing device according to claim 2, wherein
the polarized imaging unit is configured using polarized pixels having three or more different polarization directions, and
the parallax image generator calculates a polarization model based on pixel values of the polarized pixels having three or more different polarization directions and generates the parallax image based on the calculated polarization model.

6. The signal processing device according to claim 5, wherein
the parallax image generator searches for a polarization direction in which the other image included in one of the ordinary ray image and the extraordinary ray image is minimized, and generates an image having a phase difference of 90° from the image of the searched polarization direction as the parallax image.

7. The signal processing device according to claim 6, wherein the parallax image generator searches for a polarization direction in which an edge component of the polarized image based on the polarization model is minimized.

8. The signal processing device according to claim 6, wherein
the parallax image generator searches for one polarization direction of two polarized images based on the polarization model, in which a sum of differences for each pixel of the two polarized images whose polarization directions have a phase difference of 90° is maximized.

9. The signal processing device according to claim 6, wherein
the parallax image generator searches for a polarization direction having a phase difference of 45° from one polarization direction of two polarized images based on the polarization model, in which a sum of differences for each pixel of the two polarized images whose polarization directions have a phase difference of 90° is minimized.

10. The signal processing device according to claim 6, wherein
the parallax image generator searches for one polarization direction of two polarized images based on the polarization model, in which a sum of differences for each pixel between an added image of two polarized images whose polarization directions have a phase difference of 90° and a polarized image having a phase difference of 45° is minimized.

11. The signal processing device according to claim 2, wherein
the parallax image generator generates an ordinary ray image and an extraordinary ray image having a parallax in a horizontal direction as parallax images using a predetermined image parallelization function.

12. A signal processing method comprising:
allowing a polarized imaging unit to generate polarized images based on subject light incident through a birefringent material;
allowing a parallax image generator to separate images with different polarization angles using the polarized images generated by the polarized imaging unit and generate an ordinary ray image and an extraordinary ray image as parallax images; and
allowing a distance measuring unit to calculate a distance to a distance measurement position based on a parallax of the distance measurement position of the subject in the ordinary ray image and the extraordinary ray image generated by the parallax image generator.

13. A program for causing a computer to perform distance measurement using polarized images, the computer executing:
separating images with different polarization angles using polarized images based on subject light incident through a birefringent material and generating an ordinary ray image and an extraordinary ray image as parallax images; and
calculating a distance to a distance measurement position based on a parallax of the distance measurement position of the subject in the generated ordinary ray image and extraordinary ray image.
